(19) United States
(12) Patent Application Publication
(10) Pub. No.: US 2018/0198184 A1
(43) Pub. Date: Jul. 12, 2018

(54) CABLE FOR TRANSMITTING ELECTROMAGNETIC WAVES

(71) Applicant: SUMITOMO ELECTRIC INDUSTRIES, LTD., Osaka (JP)

(72) Inventor: Yutaka ONISHI, San Jose, CA (US)

(73) Assignee: SUMITOMO ELECTRIC INDUSTRIES, LTD., Osaka (JP)

(21) Appl. No.: 15/403,335

(22) Filed: Jan. 11, 2017

(51) Int. Cl. H01P 3/16

(52) U.S. Cl. CPC H01P 3/16

(57) ABSTRACT

A cable for transmitting electromagnetic waves is disclosed. The cable is a cable for transmitting electromagnetic waves, and includes a core extending along a longitudinal direction of the cable, the core including a dielectric, a sleeve extending along the longitudinal direction of the cable while surrounding the core so as to provide a cavity between the core and the sleeve, the sleeve including a dielectric, and a support that supports the core in the cavity in the sleeve, the support including a dielectric.

### TECHNICAL FIELD

The present invention relates to a cable for transmitting electromagnetic waves.

### BACKGROUND

Japanese Unexamined Patent Publication No. JP08-195605 discloses a coaxial cable and a waveguide for transmitting electromagnetic waves, such as microwaves and millimeter waves. Japanese Unexamined Patent Publication No. JP06-034715 discloses not only a coaxial line and a waveguide, as a microwave line, but also a coplanar line.

### SUMMARY

The present invention relates to a cable for electromagnetic waves as one embodiment thereof. The cable for transmitting electromagnetic waves includes a core extending along a longitudinal direction of the cable, a sleeve extending along the longitudinal direction of the cable while surrounding the core so as to provide a cavity between the core and the sleeve, and a support that supports the core in the cavity in the sleeve. Each of the core, the sleeve, and the support includes a dielectric.

### BRIEF DESCRIPTION OF THE DRAWINGS

The foregoing and other purposes, aspects and advantages will be better understood from the following detailed description of embodiments of the invention with reference to the drawings, in which:

FIG. 1 is a sectional view taken along a direction perpendicular to an axial direction of a cable for millimeter waves according to a first embodiment of the present invention;

FIG. 2 illustrates an electric field intensity distribution acquired by electromagnetic field distribution calculation, in the cable for millimeter waves illustrated in FIG. 1;

FIG. 3 is a sectional view taken along a direction perpendicular to an axial direction of a cable according to a comparative example;

FIG. 4 is a sectional view taken along a direction perpendicular to an axial direction of a cable for millimeter waves according to a second embodiment of the present invention;

FIG. 5A illustrates an example of bend loss of the cable for millimeter waves illustrated in FIG. 1;

FIG. 5B illustrates an example of bend loss of the cable for millimeter waves illustrated in FIG. 4;

FIG. 6 is a sectional view taken along a direction perpendicular to an axial direction of a cable for millimeter waves according to a third embodiment of the present invention;

FIG. 7A illustrates an electric field intensity distribution when a TE mode is used as a transmission signal in the cable for millimeter waves illustrated in FIG. 1;

FIG. 7B illustrates an electric field intensity distribution when the TE mode is used as a transmission signal in the cable for millimeter waves illustrated in FIG. 6;

FIG. 8A is a sectional view taken along a direction perpendicular to an axial direction of a cable for millimeter waves according to a fourth embodiment of the present invention;

FIG. 8B is a sectional view taken along a direction perpendicular to an axial direction of a cable for millimeter waves according to a variation of the fourth embodiment of the present invention;

FIG. 9A is a sectional view taken along a direction perpendicular to an axial direction of a cable for millimeter waves according to a fifth embodiment of the present invention;

FIG. 9B is a sectional view taken along a direction perpendicular to an axial direction of a cable for millimeter waves according to a variation of the fifth embodiment of the present invention;

FIG. 10 illustrates a relationship between a real part ε′ᵣ and an imaginary part ε″ᵣ of complex permittivity, and a frequency; and

FIG. 11 is a sectional view illustrating a cross section of a conventional coaxial cable.

### DETAILED DESCRIPTION

### Description of Embodiments of the Present Invention

First, contents of the embodiments of the present invention listed below will be described. A cable for electromagnetic waves according to an embodiment of the present invention is a cable for transmitting electromagnetic waves. The cable includes a core extending along the longitudinal direction of the cable, a sleeve extending along the longitudinal direction of the cable while surrounding the core so as to provide a cavity between the core and the sleeve, and a support that supports the core in the cavity in the sleeve. Each of the core, the sleeve, and the support includes a dielectric.

The cable for electromagnetic waves is formed with the core that includes the dielectric. Accordingly, this cable prevents from increasing the resistive loss (skin resistance) that causes by concentrating electric field on a surface of a conductor such as the core to locally increase resistance when electromagnetic waves such as microwaves and millimeter waves are transmitted, whereby this cable can reduce propagation loss of the electromagnetic waves. In addition, the cable for electromagnetic waves is formed so that a cavity is formed in a region between the core and the sleeve, the region corresponding to a cladding, and thus air or the like with a dielectric loss tangent of zero is positioned in so-called a cladding corresponding region, whereby this cable can further reduce propagation loss of the electromagnetic waves of the entire cable. Further, since the cable for electromagnetic waves provides the support that supports the core in the cavity, the core is reliably supported in the sleeve, whereby the cable can secure the cavity with a predetermined size. If there is not this kind of support, the core and the sleeve are brought into contact with each other, or are adjacent to each other, to cause a higher mode propagating through the sleeve, thereby increasing loss at a receiving section. While electromagnetic waves to be transmitted through the cable for electromagnetic waves includes electromagnetic waves at 30 GHz to 300 GHz, such as millimeter waves, or extremely high frequency (EHF), for example, the cable can be used when electromagnetic waves other than the millimeter waves are transmitted.

In the cable for electromagnetic waves, the support may be formed integrally with the core, and may be fixed to an inner periphery of the sleeve. In this case, a positional relationship between the core and the sleeve is fixed, and thus transmission characteristics through the cable for electromagnetic waves can be stabilized.

In the cable for electromagnetic waves, the support may be formed integrally with the core, and may be provided to be brought into contact with the inner periphery of the sleeve. In this case, even if the cable is bent, the core and the support, integrated with each other, appropriately move in the sleeve to enable transmission characteristics through the cable for electromagnetic waves to be stabilized. This structure enables the core and the support to be easily formed with a dielectric material different from that of the sleeve, and thus the sleeve may be formed of a material harder than that of the core and the like to prevent deformation of the sleeve due to pressure from the outside, for example.

In the cable for electromagnetic waves, the support with a width less than a width or a diameter in a cross-sectional shape of the core may extend to the inner periphery of the sleeve. In this case, a wider region for cavity in the sleeve can be secured, and thus a region of air or the like with a dielectric loss tangent of zero, the region corresponding to a cladding, can be widened to further reduce propagation loss.

In the cable for electromagnetic waves, the support with a width more than a thickness of the sleeve may extend to the inner periphery of the sleeve. In this case, strength of the support can be secured to prevent breakage or the like of the support when the cable is used.

In the cable for electromagnetic waves, the support may be formed to be inclined at an angle of 45 degrees or more with respect to a direction of an electric field propagated through the core. When the support is formed to be inclined at an angle of 45 degrees or more with respect to the direction of an electric field, radiation of electromagnetic waves due to a bend of the cable can be reduced, and thus bend loss can be reduced.

In the cable for electromagnetic waves, a cross-sectional shape of the core may be any one of a square, a rectangle, a circle, an ellipse, a trapezoid, and a polygon. The cross-sectional shape of the core may have length in a long axis different from that in a short axis. In this case, TE polarized waves (transverse electric waves) and TM polarized waves (transverse magnetic waves) of electromagnetic waves to be propagated can be completely separated, and this enables a cross talk between modes by the TE polarized waves and the TM polarized waves to be reduced to achieve favorable transmission. When lengths in the long axis and in the short axis of the cross-sectional shape of the core are different from each other, polarization multiplexed communication is also available.

In the cable for electromagnetic waves, a cross-sectional shape of the core may be any one of a square, a rectangle, a trapezoid, and a polygon, and the support may be connected at its base end to a corner of the core. In this case, the support is disposed in a portion with a relatively low electric field intensity, and thus a leakage of the electric field to the support can be reduced to reduce bend loss.

The cable for electromagnetic waves may further include a metal layer that covers an outer periphery of the sleeve. In this case, even if the cable is bent, electromagnetic waves can propagate through the core, and thus can be prevented from radiating to the outside of the cable. As a result, according to the cable provided with the metal layer, electromagnetic waves radiating from the core are reflected by the metal layer to join into the core again, and thus bend loss of the cable can be reduced. A thickness of the metal layer may be 1 μm or more, and this enables the prevention of radiation described above to be more reliably performed.

In the cable for electromagnetic waves, the core, the sleeve, and the support may be formed of the same dielectric material. In this case, the cable for electromagnetic waves can be integrally and easily manufactured by extrusion molding.

In the cable for electromagnetic waves, the dielectric material constituting the core, the sleeve, and the support may contain polyethylene, polypropylene, olefin-based material, or fluorine-based material. In this case, a desired flexibility can be provided in the cable.

In the cable for electromagnetic waves, at least any one of the core, the sleeve, and the support may contain metal oxide that adjusts permittivity or dielectric loss tangent. In this case, the cable with adjusted permittivity and dielectric loss tangent can be easily formed.

In the cable for electromagnetic waves, the core, the sleeve, and the support may be formed integrally with each other. In this case, a positional relationship between the core and the sleeve is fixed, and thus transmission characteristics through the cable for electromagnetic waves can be stabilized.

The cable for electromagnetic waves may further include an auxiliary support that assists support of the core by using the support, and the auxiliary support may be provided between the support and the sleeve while being in non-contact with the core. In this case, strength of the cable against a bend can be increased without increasing propagation loss, and thus a kink can be prevented. In this case, the auxiliary support may connect and fix the support and the sleeve to each other. This enables the strength of the cable against a bend to be further increased.

In the cable for electromagnetic waves, the support may include a pair of beam members, and the pair of beam members may be provided in the sleeve to be parallel or symmetrical to each other. In this case, when electromagnetic waves deviate (leak) from the core in a bent portion, increase in bend loss due to diffuse reflection by the beam members can be prevented.

In the cable for electromagnetic waves, a ratio of the cavity in the sleeve to a total cross-sectional area of an inner periphery of the sleeve, in a cross-sectional view of the cable, may be 30% or more. In this case, propagation loss can be reduced. In addition, flexibility of the cable can be increased. Further, in the cable for electromagnetic waves, a ratio of the cavity in the sleeve to the total cross-sectional area of an inner periphery of the sleeve, in a cross-sectional view of the cable, may be 50% or more. In this case, dielectric loss can be further reduced. In addition, the flexibility of the cable can be further increased.

### Detailed Description of Embodiments of the Present Invention

A specific example of a cable according to each of embodiments of the present invention will be described below with reference to accompanying drawings. The present invention is not limited to the examples, and is intended to include all modifications that are shown in the scope of claims, and in meaning and the scope equivalent to those of claims. In description below, the same element is designated by the same reference numeral in description of the drawings, and description on the element is not duplicated.

### First Embodiment

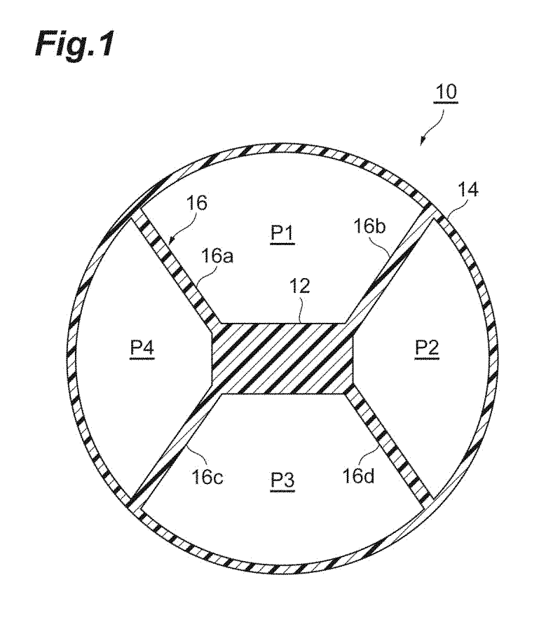

FIG. 1 is a sectional view taken along a direction perpendicular to an axial direction of a cable for millimeter waves according to a first embodiment of the present invention. A cable 10 is a cable for transmitting electromagnetic waves such as millimeter waves, for example, and includes a core 12, a sleeve 14, and a support 16. The cable 10 is formed so that cavities P1, P2, P3, and P4 are provided between the core 12 and the sleeve 14. Each of the cavities P1 to P4 defined by the support 16 is to be filled with air with a dielectric loss tangent of zero, for example. The “millimeter waves” to be used here means electromagnetic waves within a frequency band from 30 GHz to 300 GHz.

The core 12 is a region with a function of mainly transmitting the millimeter waves, and is substantially formed of a dielectric to extend along in a longitudinal direction of the cable 10. While the core 12 is in the cross-sectional shape of a rectangle with a long axis and a short axis different from each other in length in FIG. 1, the core 12 may be in the shape of any one of a square, a circle, an ellipse, a trapezoid, and a polygon. As a dielectric material constituting the core 12, plastic material, such as polyethylene, polypropylene, olefin-based material including cycloolefin polymer (COP) or cyclic olefin polymer (COC), and fluorine material of PFA, PTFE, or the like, can be shown by way of example. The core 12 may be formed of composite material in which material (metal oxide) such as Al₂O₃ and BiTiO₂ for adjusting permittivity or dielectric loss tangent is added to the plastic material described above. The sleeve 14 and the support 16 described later also can be formed of dielectric material similar to the above or composite material of the dielectric material, similar to the above.

The sleeve 14 is substantially formed of a dielectric in the shape of a cylinder, and extends along the longitudinal direction of the cable 10 to surround the core 12. As described above, the sleeve 14 is formed so that the cavities P1 to P4 each with a predetermined size are provided between the core 12 and the sleeve 14. The cavities P1 to P4 can be formed so that a total ratio of the cavities P1 to P4 in the sleeve 14 to a total cross-sectional area of the inner periphery of the sleeve 14, in a cross-sectional view of the cable 10, is to be 50% or more, and the total ratio of the cavities P1 to P4 to the total cross-sectional area of the inner periphery of the sleeve 14 may be 30% or more.

The support 16 is a member for supporting the core 12 in a region of the cavities P1 to P4 in the sleeve 14, and is substantially formed of a dielectric. The support 16 includes four plate-shaped beam members 16a, 16b, 16c, and 16d, extending from four respective corners of the core 12 to an inner peripheral surface of the sleeve 14 in a substantially radial manner, in a cross-sectional view. In FIG. 1, the support 16 is formed so that an angle between an electric field direction and each of the beam members 16a to 16d is to be 45 degrees. The beam members 16a and 16b, and the beam members 16c and 16d, are disposed to be axially symmetrical to each other with respect to a vertical line passing through the center of the core 12. In addition, the beam members 16a to 16d each can have a width that is less than a width (in the long axis and the short axis) of the core 12 in a cross-sectional shape, or a diameter (in a case where a cross-sectional shape is a circle), and that is more than a thickness of the sleeve 14. The beam members 16a to 16d formed as described above connect the core 12 to the sleeve 14 as supports of the core 12. Base ends of the beam members 16a to 16d are fixed to the corresponding corners of the core 12, and leading ends thereof are fixed to an inner periphery of the sleeve 14. Each of the beam members 16a to 16d constituting the support 16 may be a plate-like member continuously extending along the longitudinal direction of the cable by a constant length, or a plate-like member that intermittently has an opening whose length is variable. The core 12, the sleeve 14, and the support 16, may be integrally formed with the same material, or may be separately formed with different materials to be connected to each other.

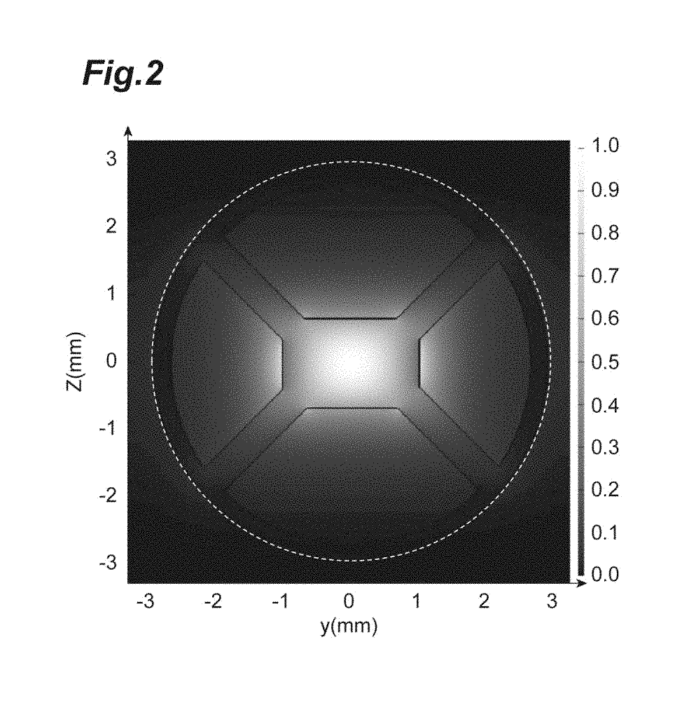

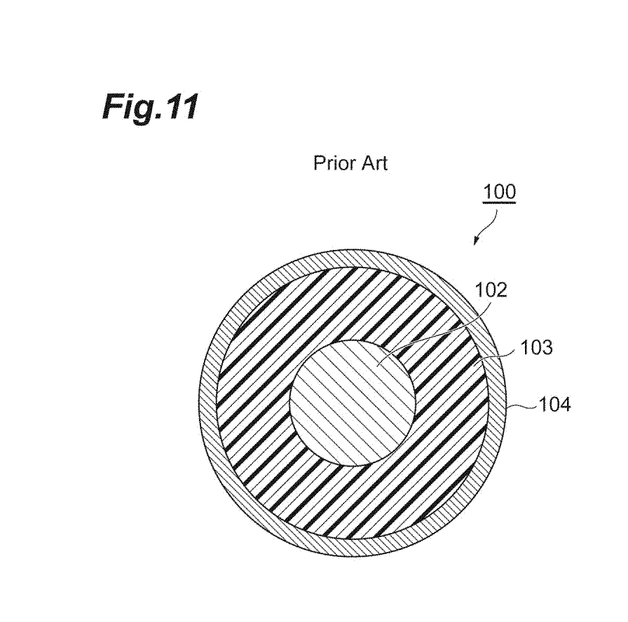

Operation effect of the cable 10 including the structure described above will be described with reference to FIG. 2. FIG. 2 illustrates an electric field intensity distribution acquired by electromagnetic field distribution calculation, in the cable for millimeter waves illustrated in FIG. 1. A white region in FIG. 2 shows a region with high electric field intensity, and a blacker region has a lower electric field intensity. First, when electromagnetic field distribution calculation was performed, polyethylene was selected as a dielectric material constituting the core 12, the sleeve 14, and the support 16, and then a width of the core 12 in the short axis direction (a vertical direction in FIG. 2) was set at 1.3 mm, a width of the core 12 in the long axis direction (a side-to-side direction in FIG. 2) was set at 2.4 mm, an outer diameter of the sleeve 14 is set at 6 mm, the thickness (width) of the sleeve 14 was set at 0.3 mm, and a width of each of the beam members 16a to 16d of the support 16 was set at 0.4 mm. Then, an electric field intensity distribution transmission was acquired by electromagnetic field distribution calculation of a basic mode (fundamental mode) in a case where a frequency of electromagnetic waves to be transmitted was 100 GHz. The term “basic mode” here is the same as a mode by TE polarized waves in TE polarized waves (Transverse Electric Waves) and TM polarized waves (Transverse Magnetic Waves). As illustrated in FIG. 2, it was perceived that the core 12 formed of a dielectric has a peak of electric field intensity in the cable for millimeter waves illustrated in FIG. 1. In this case, propagation loss in the basic mode was 6.5 dB/m, and thus it was perceived that a cable with the structure illustrated in FIG. 1 was able to be greatly reduced in propagation loss as compared with a conventional coaxial cable (refer to a coaxial cable 100 illustrated in FIG. 11) in which a propagation loss of 14 dB/m was calculated under conditions similar to the above.

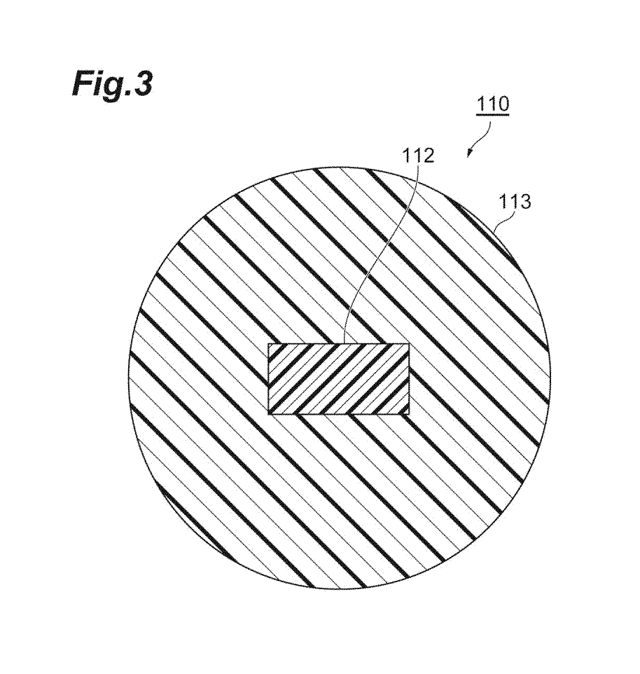

It is thought that the results described above was caused by the following: in the conventional coaxial cable 100, as a frequency of electromagnetic waves to be transmitted increases, an electric field was concentrated on surfaces of conductors 102 and 104, and thus, the loss was increased by skin resistance that locally increased resistance. In contrast, the cable 10 according to the present embodiment does not use a conductor, and thus loss due to the skin resistance can be prevented from occurring even when high-frequency waves at 100 GHz are transmitted. While a cable 110 with structure in which a core 112 is covered with another dielectric (e.g. polypropylene) as illustrated in FIG. 3, for example, can be studied as cable structure without skin resistance, even in this case, another dielectric material is disposed in a region corresponding to a cladding 113, and thus, when propagation loss of the cable structure is calculated under conditions similar to those described above, for example, the propagation loss is 8.2 dB/m, which is higher than that of the present embodiment.

That is, in the cable 10 according to the present embodiment, the core 12 is formed of a dielectric, and a region between the core 12 and the sleeve 14, corresponding to a cladding, is formed of the cavities P1 to P4. Accordingly, when radio waves such as microwaves and millimeter waves are transmitted, not only increase in loss due to locally increased resistance (skin resistance) caused by an electric field concentrated on a surface of a conductor of the core 12 and the like is reduced, but also propagation loss of millimeter waves can be further reduced, because a region corresponding to claddings 103 and 113 is formed to be the cavities P1 to P4 to allow air or the like with a dielectric loss tangent of zero to be positioned in a cladding corresponding region. In addition, the cable 10 for millimeter waves is provided with the support 16 for supporting the core 12, in the region of the cavities P1 to P4, and thus the core 12 is to be reliably supported in the sleeve 14 to enable transmission characteristics to be stabilized. As describe above, the cable 10 for millimeter waves according to the present embodiment enables flexibility to be provided in a cable while reducing transmission loss when millimeter waves are transmitted.

In the cable 10 for millimeter waves, the support 16 is formed integrally with the core 12, and is fixed to the inner periphery of the sleeve 14. Thus, a positional relationship between the core 12 and the sleeve 14 is fixed, and also the region of the cavities P1 to P4 can be stabilized, whereby transmission characteristics through the cable 10 for millimeter waves can be stabilized.

In the cable 10 for millimeter waves, the support 16 with a width less than a width or a diameter in a cross-sectional shape of the core 12 extends to the inner periphery of the sleeve 14. Accordingly, a wider region for the cavities P1 to P4 in the sleeve 14 can be secured, and thus a region of air or the like with a dielectric loss tangent of zero, the region corresponding to a cladding, can be widened to further reduce transmission loss.

In the cable 10 for millimeter waves, the support 16 with a width more than a thickness of the sleeve 14 extends to the inner periphery of the sleeve 14. Accordingly, breakage or the like of the support 16 can be prevented when the cable 10 is used.

In the cable 10 for millimeter waves, the support 16 is provided to be inclined at an angle of 45 degrees with respect to a direction of an electric field propagated through the core 12. Accordingly, radiation of electromagnetic waves due to a bend of the cable can be reduced, and thus bend loss can be reduced. The support 16 may be provided to be inclined at an angle of 45 degrees or more with respect to the direction of an electric field propagated through the core 12.

In the cable 10 for millimeter waves 10, while a cross-sectional shape of the core 12 may be any one of a square, a rectangle, a circle, an ellipse, a trapezoid, and a polygon, a shape with length in a long axis and length in a short axis, different from each other, such as a rectangle, an ellipse, and a trapezoid, is preferable. In this case, TE polarized waves and TM polarized waves of electromagnetic waves to be propagated can be completely separated, and this enables a cross talk between modes by both the polarized waves to be reduced. When lengths in the long axis and in the short axis of the cross-sectional shape of the core 12 are different from each other, polarization multiplexed communication is also available.

In the cable 10 for millimeter waves, at least any one of the core 12, the sleeve 14, and the support 16, can contain metal oxide to adjust permittivity or dielectric loss tangent. In this case, the cable 10 with adjusted permittivity and dielectric loss tangent can be easily manufactured.

### Second Embodiment

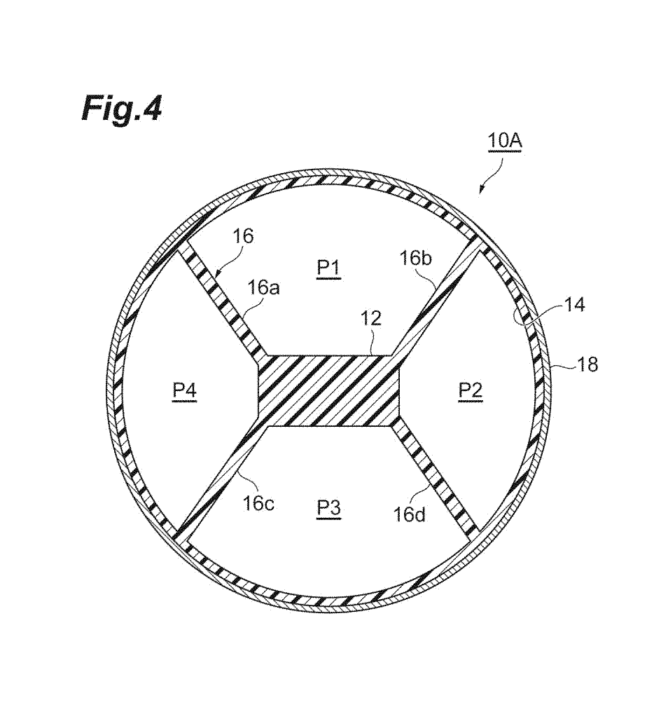

Next, a cable for millimeter waves according to a second embodiment of the present invention will be described with reference to FIG. 4. FIG. 4 is a sectional view taken along a direction perpendicular to an axial direction of the cable for millimeter waves according to the second embodiment of the present invention. A cable 10A for millimeter waves illustrated in FIG. 4 includes a core 12, a sleeve 14, and a support 16, as with the cable 10 for millimeter waves of the first embodiment, and further includes a metal layer 18 formed of an aluminum film on an outer periphery of the sleeve 14. The metal layer 18 is a layer serving as a reflecting mirror, and has a thickness of 1 μm or more, for example. The metal layer 18 may be formed by wrapping a film-like member around the outer periphery of the sleeve 14, or may be formed by directly applying plating thereto. As the metal layer 18, copper, gold, or the like, other than aluminum, may be used.

According to the cable 10A for millimeter waves, with the structure described above, in addition to the effect of the cable 10 for millimeter waves according to the first embodiment, even when the cable 10A is bent, electromagnetic waves can propagate through the core 12, and thus radiation of transmitting millimeter waves or the like to the outside of the cable 10A can be reduced by the metal layer 18 positioned in the outer periphery of the cable. As a result, according to the cable 10A for millimeter waves, provided with the metal layer 18, millimeter waves radiating from the core 12 are reflected by the metal layer 18 to join into the core 12 again, and thus bend loss of the cable 10A can be reduced.

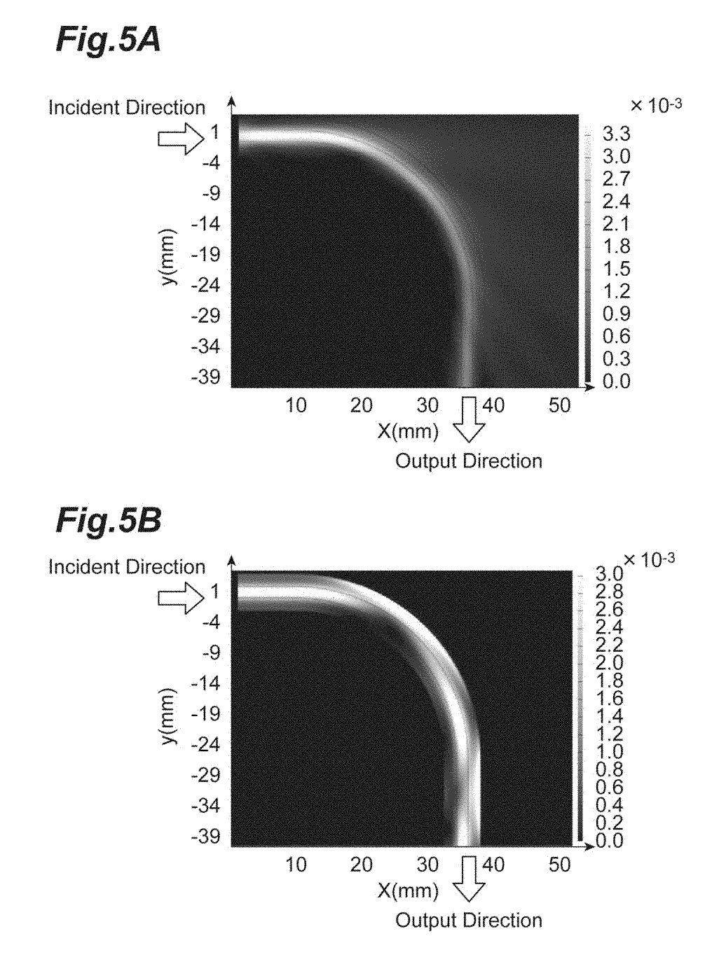

The operation effect described above will be described with reference to FIGS. 5A and 5B. FIG. 5A illustrates an example of bend loss of the cable for millimeter waves illustrated in FIG. 1. FIG. 5B illustrates an example of bend loss of the cable for millimeter waves illustrated in FIG. 4. FIGS. 5A and 5B each show a state of propagation in a bent portion when the cables 10 and 10A for millimeter waves each are bent in a long axis direction of the core 12 by 90 degrees at a radius of 25 mm. While some of millimeter waves propagating through the cable from an incident direction of millimeter waves to an output direction thereof radiated to the outside of the cable (electric field intensity in the cable was reduced in some portions) in FIG. 5A, FIG. 5B shows a state where millimeter waves propagating through the cable from an incident direction of millimeter waves to an output direction thereof did not radiate to the outside of the cable (electric field intensity in the cable was not reduced), and were reflected by the metal layer 18 (an aluminum film) to join into the core 12 again. That is, it was perceived that bend loss was reduced by providing the metal layer 18 such as an aluminum film. When bend loss in the examples shown in FIGS. 5A and 5B was calculated, a calculation result of bend loss in the example of FIG. 5A was 4.5 dB/bend, in contrast, a calculation result of bend loss in the example of FIG. 5B was reduced to 0.6 dB/bend, and thus it was perceived that propagation characteristics was further improved.

### Third Embodiment

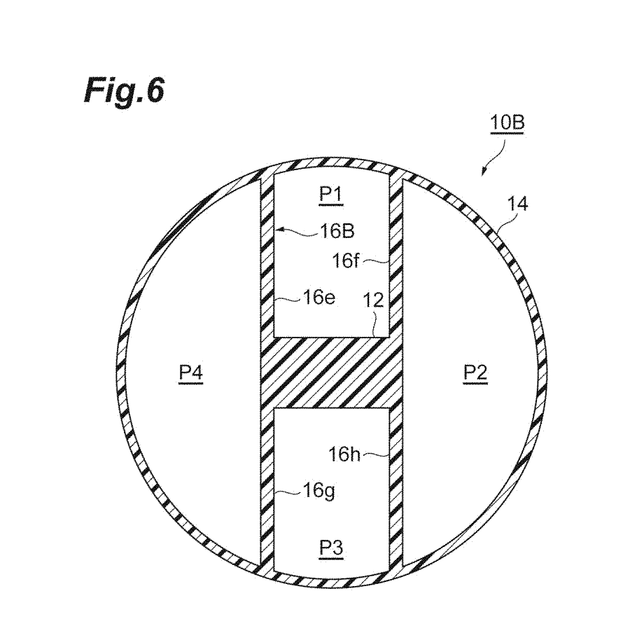

Subsequently, a cable for millimeter waves according to a third embodiment of the present invention will be described with reference to FIG. 6. FIG. 6 is a sectional view taken along a direction perpendicular to an axial direction of the cable for millimeter waves according to the third embodiment of the present invention. A cable 10B for millimeter waves illustrated in FIG. 6 includes a core 12, a sleeve 14, and a support 16B, as with the cable 10 for millimeter waves of the first embodiment. While the support 16B has material composition and the like similar to those of the support 16 of the first embodiment, a placement direction of the support 16B is different from that of the support 16 of the first embodiment. The support 16B is provided to have an angle of 90 degrees with respect to a direction of an electric field propagated through the core 12. In addition, beam members 16e and 16f, and beam members 16g and 16h, constituting the support 16B, are formed to be parallel to each other.

In a case where a TE mode having an electric field in a long axis direction of a core in the shape of a rectangle is used for a transmission signal, in a cable with a rectangular core, bending the cable in the long axis direction of the core typically causes large propagation loss. However, in the cable 10B with the structure described above, even if the cable 10B is bent in the long axis direction of the core 12, bend loss caused by bending the cable 10B for millimeter waves in the long axis direction of the core 12 can be reduced by disposing the beam members 16e to 16h constituting the support 16B to have an angle of 90 degrees with respect to an electric field direction (to be along a short axis direction of the core 12).

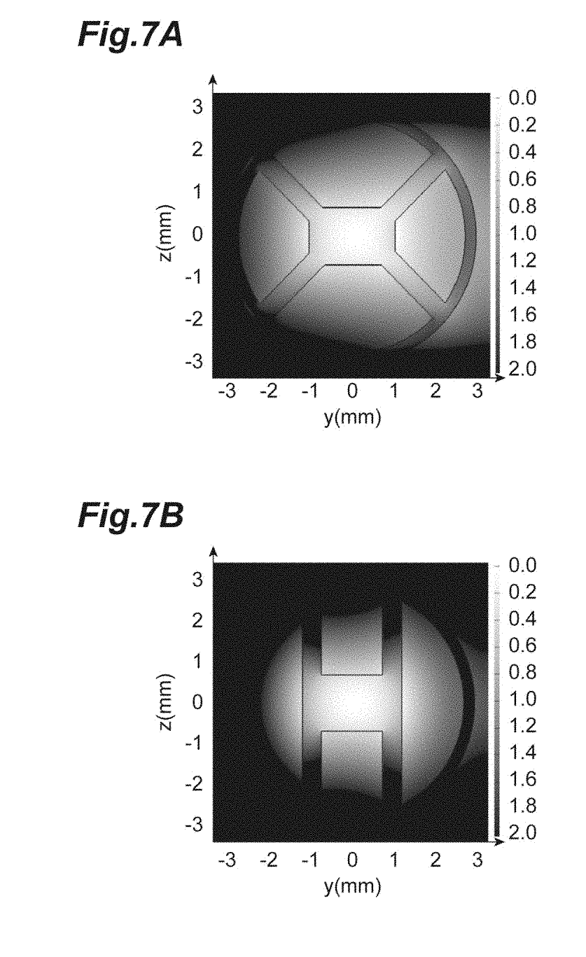

The operation effect described above will be described with reference to FIGS. 7A and 7B. FIG. 7A illustrates an example of bend loss of the cable for millimeter waves illustrated in FIG. 1. FIG. 7B illustrates an example of bend loss of the cable for millimeter waves illustrated in FIG. 6. FIGS. 7A and 7B respectively show electric field intensity distributions of the cables 10 and 10B, in portions in each of which a bend was ended when each of the cables 10 and 10B was bent in the long axis direction of the core 12 by 90 degrees at a radius of 25 mm. In the example shown in FIG. 7A, when the cable 10 was bent, an electric field leaked out to the beam members 16b and 16d on a side opposite to a bent direction (two beam members on a right side in FIG. 7A), and thus electromagnetic waves were rather likely to radiate from the core 12 to spread throughout the inside of the cable 10, and then an emission of the electromagnetic waves to the outside of the cable tended to rather increase. In contrast, in the example shown in FIG. 7B, the beam members of the cable 10B extended in a direction orthogonal to an electric field, and thus even if the cable 10B was bent, a leakage of the electric field was less likely to occur, and then it was perceived that electromagnetic waves were relatively trapped in the core 12 even in a bent portion, and an emission of the electromagnetic waves to the outside of the cable was reduced. That is, it was perceived that a leakage of an electric field to the beam members 16e to 16h in the bent portion was able to be reduced by disposing each of the beam members 16e to 16h of the support 16B to have an angle of 90 degrees with respect to the electric field direction.

While it is more preferable that a placement angle of each of the beam members with respect to the electric field direction is 90 degrees or more as described above, an angle of 45 degrees or more enables a leakage of the electric field in a bent portion to be reduced as shown in FIG. 7A. When bend loss in the examples shown in FIGS. 7A and 7B was calculated, a calculation result of bend loss in the example of FIG. 7A was 4.5 dB/bend, in contrast, a calculation result of bend loss in the example of FIG. 7B was reduced to 2.3 dB/bend. In addition, when a metal layer 18 of an aluminum film similar to that of the second embodiment was provided in an outer periphery of the cable in the example of FIG. 7B, it was perceived that bend loss was further reduced to 0.4 dB/bend. The cable 10B according to the present embodiment also can achieve operation effect similar to that of the cable 10 according to the first embodiment.

### Fourth Embodiment

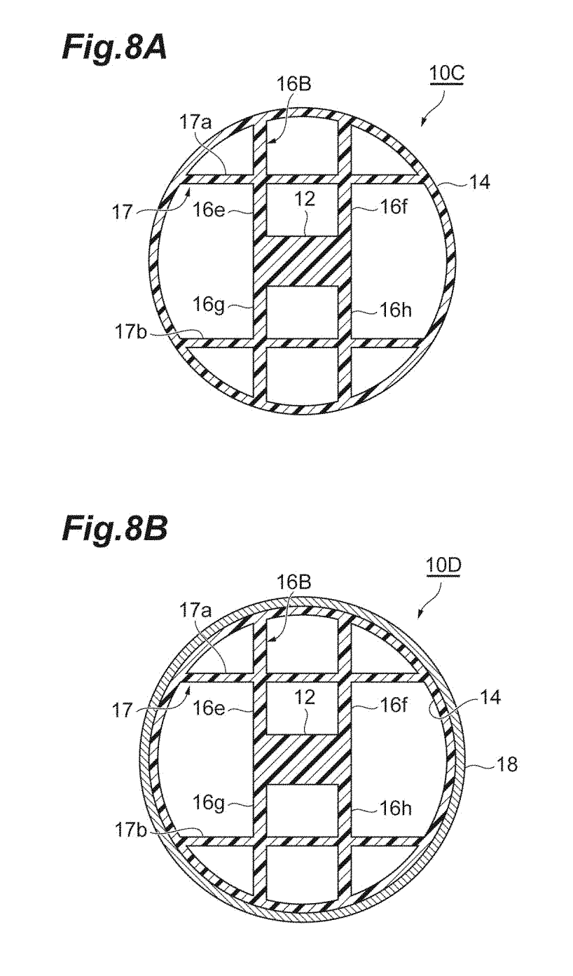

Subsequently, a cable for millimeter waves according to a fourth embodiment of the present invention will be described with reference to FIGS. 8A and 8B. FIG. 8A is a sectional view taken along a direction perpendicular to an axial direction of the cable for millimeter waves according to the fourth embodiment of the present invention, and FIG. 8B is a sectional view taken along a direction perpendicular to an axial direction of a cable for millimeter waves according to a variation of the fourth embodiment of the present invention. A cable 10C for millimeter waves illustrated in FIG. 8A includes a core 12, a sleeve 14, and a support 16B provided with beam members 16e to 16h, as with the cable 10B for millimeter waves of the third embodiment, and further includes an auxiliary support 17. The auxiliary support 17 assists support of the core 12 by using the support 16B, and is formed of plate-shaped beam members 17a and 17b that are provided to be orthogonal to the corresponding beam members 16e to 16h constituting the support 16B at an intermediate portion of each of the beam members.

The beam members 17a and 17b are provided not to be directly in contact with the core 12 formed of a dielectric, and thus can increase strength of the cable 10C against a bend without increasing propagation loss in the cable 10C. For example, while a kink (twist or tangle) is caused at a bend radius of 22 mm when the core 12 is bent in its long axis direction in the cable 10B according to the third embodiment, the cable 10C according to the present embodiment can prevent a kink up to a bend radius of 18 mm. A metal layer 18 similar to that of the second embodiment may be provided around an outer periphery of the cable 10C illustrated in FIG. 8A to form a cable 10D illustrated in FIG. 8B. In this case, bend loss can be further reduced. The cables 10C and 10D according to the present embodiment also can achieve operation effect similar to that of the cable 10 according to the first embodiment.

### Fifth Embodiment

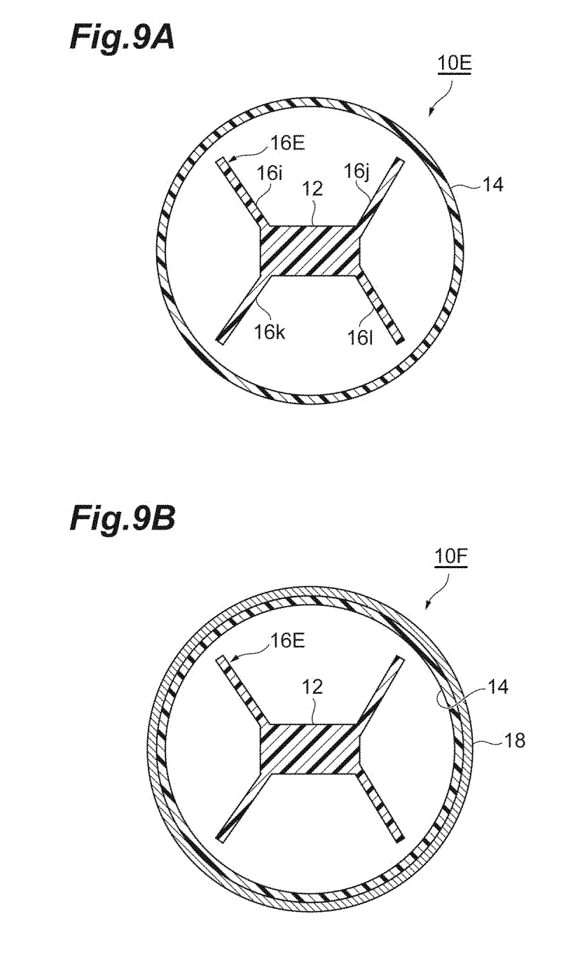

Subsequently, a cable for millimeter waves according to a fifth embodiment of the present invention will be described with reference to FIGS. 9A and 9B. FIG. 9A is a sectional view taken along a direction perpendicular to an axial direction of the cable for millimeter waves according to the fifth embodiment of the present invention, and FIG. 9B is a sectional view taken along a direction perpendicular to an axial direction of a cable for millimeter waves according to a variation of the fifth embodiment of the present invention. A cable 10E for millimeter waves illustrated in FIG. 9A includes a core 12, a sleeve 14, and a support 16E, as with the cable 10 for millimeter waves of the first embodiment. In the cable 10E for millimeter waves illustrated in FIG. 9A, the core 12 and the support 16E are integrally formed of the same dielectric material, however, the sleeve 14 is not connected to a leading end of each of beam members 16i to 16l of the support 16E, and is separated therefrom to be formed as a separate member. In this case, the sleeve 14 may be formed of a dielectric material identical to or different from that of the core 12 and the like.

The support 16E of the cable 10E for millimeter waves has a length that allows the support 16E to slightly fail to reach an inner periphery of the sleeve 14, as illustrated in FIG. 9A, and Cable 10E is formed in the longitudinal direction to have a portion that is to be in contact with the inner periphery of the sleeve due to gravity, together with a portion that is not in contact therewith. In the cable 10E for millimeter waves described above, a core 12 with beams, having a size slightly smaller than an inner diameter of the sleeve 14, is previously formed, and then the core 12 with beams is inserted into the cylindrical sleeve 14 to enable the cable to be manufactured. In this case, it is possible to easily manufacture a cable, as compared with a case where all of a cable with some hollow portions, such as the cable 10 according to the first embodiment, is integrally formed.

While a dielectric material constituting the core 12 with beams may be identical to a dielectric material constituting the sleeve 14, in the cable 10E for millimeter waves, the cable 10E also can have a structure for preventing deformation due to pressure from the outside of the cable by using a dielectric material constituting the sleeve 14 harder than a dielectric material constituting the core 12 with beams. As with the fourth embodiment, a metal layer 18 similar to that of the second embodiment may be provided around an outer periphery of the cable 10E illustrated in FIG. 9A to form a cable 10F illustrated in FIG. 9B. In this case, bend loss can be further reduced. In addition, the metal layer 18 also can be provided (applied) on an inner periphery side of the sleeve 14 in this case.

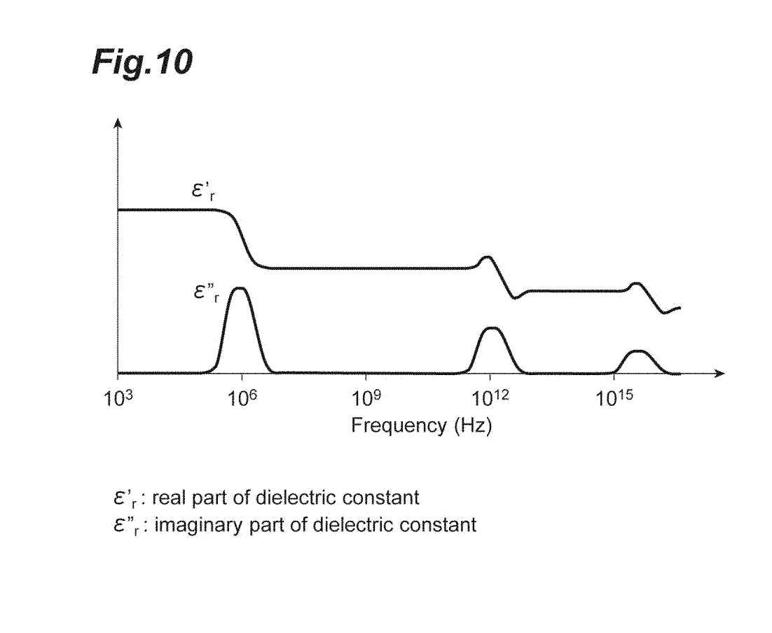

While the embodiments of the present invention are described in detail above, the present invention is not limited to the embodiments described above, and can be applied to various embodiments. For example, while millimeter waves are described as electromagnetic waves to be transmitted in the embodiments described above, this is because it is desirable to use a frequency with a small imaginary part ε″ᵣ of complex permittivity to reduce dielectric loss in a cable, as illustrated in FIG. 10. Thus, while electromagnetic waves of millimeter waves with a range from 30 GHz to 300 GHz are suitable for transmission, the cable according to the present embodiment may be obviously used for transmission using electromagnetic waves other than the millimeters wave, if dielectric loss in the cable is within an allowable range. In addition, for example, while a case where air is injected into the cavities P1 to P4 is described as an example in the embodiments described above, a fluid other than air may be injected into the cavities P1 to P4, if dielectric loss tangent can be achieved to be zero or close to zero.

What is claimed is:

1. A cable for transmitting electromagnetic waves, the cable comprising:
a core extending along a longitudinal direction of the cable, the core including a dielectric;
a sleeve extending along the longitudinal direction of the cable while surrounding the core so as to provide a cavity between the core and the sleeve, the sleeve including a dielectric; and
a support that supports the core in the cavity in the sleeve, the support including a dielectric.

2. The cable according to claim 1,
wherein the support is formed integrally with the core, and is fixed to an inner periphery of the sleeve.

3. The cable according to claim 1,
wherein the support is formed integrally with the core, and is provided to be brought into contact with an inner periphery of the sleeve.

4. The cable according to claim 1,
wherein the support with a width less than a width or a diameter in a cross-sectional shape of the core extends to an inner periphery of the sleeve.

5. The cable according to claim 1,
wherein the support with a width more than a thickness of the sleeve extends to an inner periphery of the sleeve.

6. The cable according to claim 1,
wherein the support is provided to be inclined at an angle of 45 degrees or more with respect to a direction of an electric field propagated through the core.

7. The cable according to claim 1,
wherein a cross-sectional shape of the core is any one of a square, a rectangle, a circle, an ellipse, a trapezoid, and a polygon.

8. The cable according to claim 1,
wherein lengths in a long axis and in a short axis of a cross-sectional shape of the core are different from each other.

9. The cable according to claim 1,
wherein a cross-sectional shape of the core is any one of a square, a rectangle, a trapezoid, and a polygon, and
wherein the support is connected at its base end to a corner of the core.

10. The cable according to claim 1, further comprising:
a metal layer that covers an outer periphery of the sleeve.

11. The cable according to claim 10,
wherein a thickness of the metal layer is 1 μm or more.

12. The cable according to claim 1,
wherein the core, the sleeve, and the support are formed of same dielectric material.

13. The cable according to claim 1,
wherein a dielectric material constituting the core, the sleeve, and the support contains polyethylene, polypropylene, olefin-based material, or fluorine-based material.

14. The cable according to claim 1,
wherein at least any one of the core, the sleeve, and the support contains metal oxide to adjust permittivity or dielectric loss tangent.

15. The cable according to claim 1,
wherein the core, the sleeve, and the support are formed integrally with each other.

16. The cable according to claim 1, further comprising:
an auxiliary support that assists support of the core using the support, wherein the auxiliary support is provided between the support and the sleeve while being in non-contact with the core.

17. The cable according to claim 16,
wherein the auxiliary support connects and fixes the support and the sleeve to each other.

18. The cable according to claim 1,
wherein the support includes a pair of beam members, and the pair of beam members are provided in the sleeve to be parallel or symmetrical to each other.

19. The cable according to claim 1,
wherein a ratio of the cavity in the sleeve to a total cross-sectional area of an inner periphery of the sleeve, in a cross-sectional view of the cable, is 30% or more.

20. The cable according to claim 1,
wherein a ratio of the cavity in the sleeve to a total cross-sectional area of an inner periphery of the sleeve, in a cross-sectional view of the cable, is 50% or more.
